(19) United States
(12) Patent Application Publication
(10) Pub. No.: US 2019/0381840 A1
(43) Pub. Date: Dec. 19, 2019

(54) EXTERNALLY MOUNTED TIRE INFLATION SYSTEM

(71) Applicant: Equalaire Systems, Inc., Corpus Christi, TX (US)

(72) Inventors: Mark Kevin Hennig, Corpus Christi, TX (US); Jonathan Gravell, San Antonio, TX (US)

(21) Appl. No.: 16/479,390

(22) PCT Filed: Jan. 19, 2018
(86) PCT No.: PCT/US18/14571

§ 371 Date: Jul. 19, 2019

Related U.S. Application Data
(60) Provisional application No. 62/448,280, filed on Jan. 19, 2017.

(51) Int. Cl. B60C 23/00

(52) U.S. Cl. CPC B60C 23/003

(57) ABSTRACT

A tire inflation system integrated with vehicle aerodynamic and wheel-end components, such as fairings, wheel covers and mud shields. Fluid conduits may route pressurized fluid from a fluid pressure source to a rotary union mounted at a wheel end. The fluid conduits may be routed along or through various aerodynamic and wheel-end components.

### CROSS-REFERENCE TO RELATED APPLICATION

This application claims priority to U.S. Provisional Patent Application 62/448,280 entitled “Externally Mounted Tire Inflation System” filed Jan. 19, 2017, which is hereby entirely incorporated herein by reference.

### FIELD

This application relates generally to mounting external vehicle tire inflation systems on tractor-trucks and trailers.

### BACKGROUND

There exists a need for systems and methods of mounting tire inflation components for mounting on the outside of a truck or trailer.

### SUMMARY

A vehicle tire inflation system comprising a fluid pressure source and a rotary union mounted to or under an aerodynamic wheel cover, the rotary union being in sealed fluid communication with the fluid pressure source and one or more vehicle tires.

A vehicle tire inflation system comprising a fluid pressure source and a rotary union mounted to a wheel end of the vehicle and in sealed fluid communication with one or more vehicle tires, the rotary union being in sealed fluid communication with the fluid pressure source through a fluid conduit disposed through or along an aerodynamic fairing mounted to the vehicle.

### BRIEF DESCRIPTION OF THE DRAWINGS

FIG. 1 illustrates an inflation system integrated into aerodynamics components installed on a truck-tractor.

FIG. 2 illustrates another embodiment of an inflation system integrated into aerodynamics components installed on a truck-tractor.

FIG. 3 illustrates yet another embodiment of an inflation system integrated into aerodynamics components installed on a truck-tractor.

FIG. 4 illustrates a further embodiment of an inflation system integrated into aerodynamics components installed on a truck-tractor.

FIG. 5 illustrates another embodiment of an inflation system integrated into aerodynamics components installed on a truck-tractor.

FIG. 6 illustrates another embodiment of an inflation system integrated into aerodynamics components installed on a truck-tractor.

FIG. 7 illustrates a wheel cover with integrated inflation system components.

FIG. 8 illustrates a wheel cover locking hub with an integrated rotary union.

FIG. 9 illustrates a center tandem fairing with integrated inflation components.

FIG. 10 illustrates another view of a center tandem fairing with integrated inflation components.

FIG. 11 illustrates a rear view of support arm for a center tandem fairing with integrated inflation components.

FIG. 12 illustrates a side view of support arm for a center tandem fairing with internally integrated inflation components.

FIG. 13 illustrates a side view of support arm for a center tandem fairing with integrated inflation components, wherein the arm is pressurized.

FIG. 14 illustrates a support arm for a mud flap or fender with an integrated inflation system.

FIG. 15 illustrates a support arm for a mud flap or fender with an externally integrated inflation system.

FIG. 16 illustrates one embodiment of an externally-mountable rotary union.

FIG. 17 illustrates another embodiment of an externally-mountable rotary union.

FIG. 18 illustrates another embodiment of a wheel cover base assembly.

### DETAILED DESCRIPTION

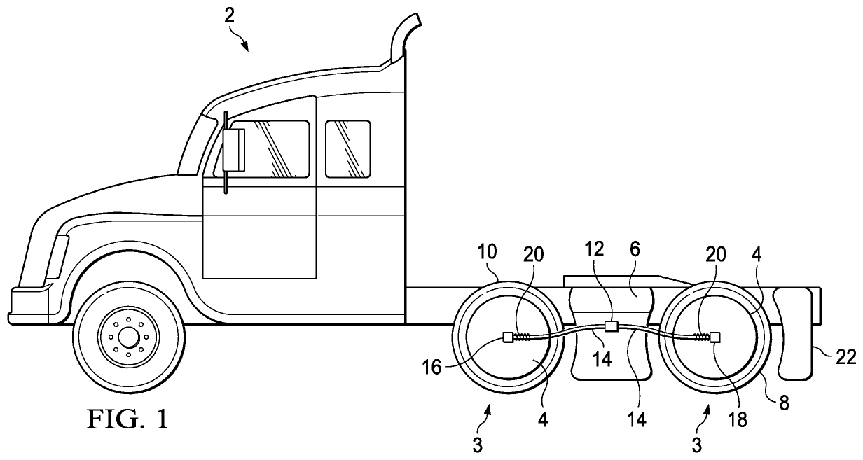

Vehicle aerodynamics may be improved by adding fairings around the wheels, and/or by adding wheel covers to cover the wheel hubs. Such fairings and wheel hubs may be added to truck-tractors and trailers. For example, as may be seen in FIG. 1, the area around the drive wheels 3 of a truck-tractor 2 may be made more aerodynamic by adding one or more wheel covers 4 on the truck wheels 3, a center tandem fairing 6 disposed between the rearmost and forward rear tire sets 8 and 10, and a rear fairing 22 disposed behind the rearmost tires of the truck-tractor 2. The addition of such parts may reduce drag in areas around the wheel of a vehicle. As described herein, a tire inflation system may be used in connection with, or integrated into, various fairing and wheel cover combinations. An inflation system may comprise one or more fluid distribution connections 12, fluid transfers conduits 14, rotary unions 16 and 18 and other such components as may be provided for an inflation system, such as a fluid pressure source and pressure regulator.

As may be seen in the embodiment of FIG. 1, a fluid distribution connection 12 may be mounted to a center tandem fairing 6. The distribution connection 12 may receive pressurized fluid from a pressure source, such as an air brake system, compressor, or other pressurized fluid reservoir. The fluid distribution connection 12 may be in sealed fluid communication with one or more rotary unions 16 and 18 mounted to the wheel end of a truck-tractor 2 or other compatible vehicle or trailer. The sealed fluid communication may be provided by a fluid transfer conduit 14 connecting the distribution connection 12 with the rotary unions 16 and 18. Said fluid conduit 14 may be a flexible hose, rigid tubing, or other conduit suitable for pressurized fluid transfer. The fluid conduit 14 may be of any suitable construction, such as braided metal, synthetic or natural polymer, other suitable material, or a combination thereof. A non-rigid conduit, such as a hose, may be provided with a strain relief 20 that partially or fully covers the length of the conduit. A fluid conduit 14 may be resistant to abrasion, appropriate for temperatures as normally found in travel through a region in which truck-tractors may be utilized, resistant to chemicals normally associated with operation of a truck-tractor, and other environmental hazards as associated with operation of a truck-tractor. A fluid conduit may couple with fluid conduit connectors through use of threaded connections, quick-disconnect socket systems, push-to-connect systems, twist-claw connectors, or other appropriate fluid-tight conduit coupling systems. Such connections may typically be made of brass, stainless steel, or any of a variety of polymers, plastics or metals.

Pressurized fluid may thus flow from the distribution connection 12 to the rotary unions 16 and 18 disposed through wheel covers 4. The rotary unions 16 and 18 may in turn provide the pressurized fluid to one or more vehicle tires in the rearmost and forward rear tire sets 8 and 10, such as may be described in Applicant's co-pending application U.S. Ser. No. 15/035,695, the subject matter of which is incorporated wholly herein by reference. Of course, any other suitable fluid rotary union may be used. A strain relief 20, such as a coil spring, may be disposed over part or the entirety of any non-rigid fluid transfer conduit 14 so as maintain positioning of the conduit while yet allowing some displacement to minimize stress at the fittings of the conduit 14.

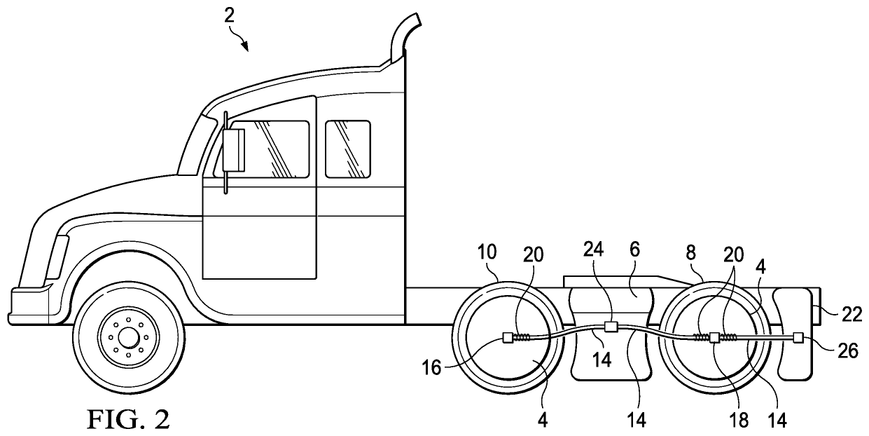

In other embodiments, such as may be seen in FIG. 2, the upstream components of an inflation system (such as a pressure source, not shown) may provide fluid to a fluid conduit connector 26 located at a rear fairing 22. In such a configuration, the conduit connector 26 provides fluid communication through a fluid conduit 14 to the rearmost tire set 8 through a rotary union 18 mounted to or through the wheel cover 4. The rotary union 18 in turn communicates fluid not only to the tires 8, but also through fluid conduit 14 to the rotary union 16 mounted at the forward rear tire set 10. The center tandem fairing 6 may have a fluid conduit coupling 24 disposed so as to inter-connect and support the fluid conduit 14. Alternatively, the conduit coupling 24 may be replaced by a support bracket (not shown) to support the fluid conduit 14 along its length between rotary union 16 and rotary union 18. The fluid conduit 14 may thus connect the rotary union 16 for the forward rear tire set 8 to the rotary union 18 for the rearmost tire set 10. A strain relief 20, such as a coil spring, may be disposed over part or the entirety of any non-rigid fluid transfer conduit 14 so as maintain positioning of the conduit while yet allowing some displacement to minimize stress at the fittings of the conduit 14.

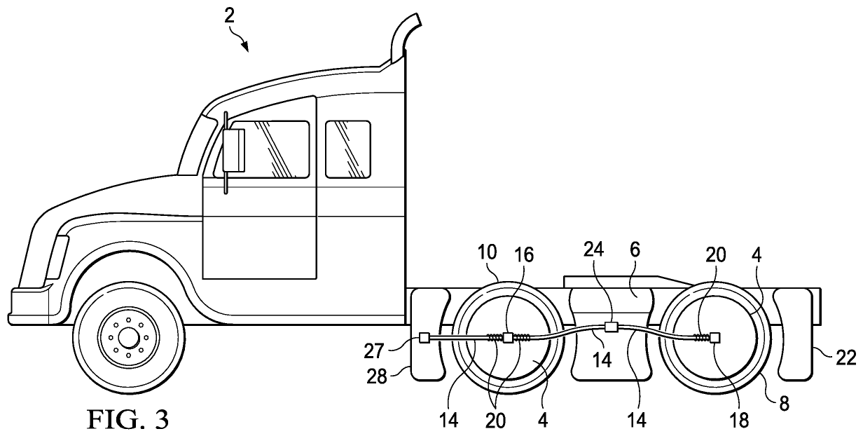

In another embodiment, as seen in FIG. 3, a forward fairing 28 may be provided on the truck-tractor 2 in addition to a center tandem fairing 6, and a rear fairing 22. In such a configuration, upstream inflation system components, such as a fluid pressure source (not shown), may provide fluid to a fluid conduit connector 27 disposed on the forward fairing 28. The connector 27 may provide fluid communication with the forward rear tire set 10 through a conduit 14 and a rotary union 16 mounted to or through wheel cover 4. The fluid conduit 14 may then provide fluid communication from the rotary union 16 to a conduit coupling 24 disposed at the center tandem fairing 6. The rearmost tire set 8 may be in fluid communication with the inflation system through fluid conduit 14 connected to a conduit coupling 24 to rotary union 18 mounted to or through wheel cover 4. Alternately, the conduit coupling 24 may be replaced with a support bracket (not shown) to support the fluid conduit 14 along its length between rotary union 16 and rotary union 18. A strain relief 20, such as a coil spring, may be disposed over part or the entirety of any non-rigid fluid transfer conduit 14 so as maintain positioning of the conduit while yet allowing some displacement to minimize stress at the fittings of the conduit 14.

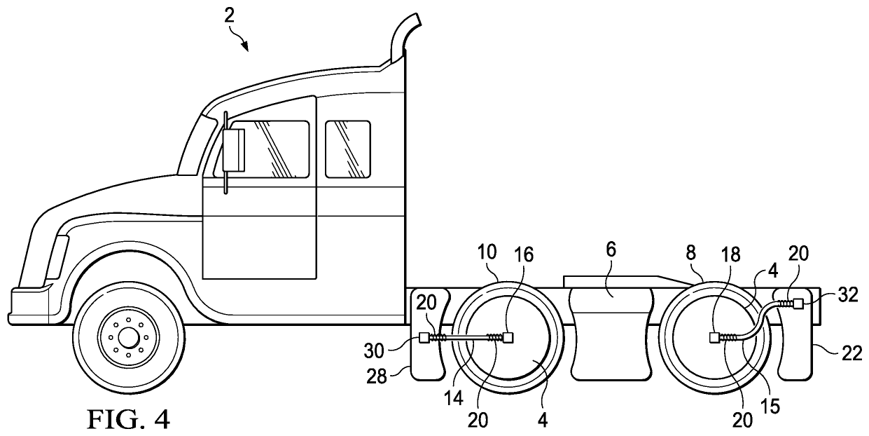

In another embodiment, as seen in FIG. 4, a truck-tractor 2 may include aerodynamic components such as covers 4, a forward fairing 28, a center tandem fairing 6, and a rear fairing 22. In such a configuration, upstream inflation system components, such as a fluid pressure source (not shown), may provide fluid to a first fluid conduit connector 30 disposed on the forward fairing 28. The conduit connector 30 may provide fluid communication with the forward rear tire set 10 through a fluid conduit 14 and a rotary union 16. For the rearmost tire set 8, the fluid pressure source may provide fluid to a second fluid conduit connector 32 disposed on the rear fairing 22. The fluid conduit connector 32 may provide fluid communication with the rear tire set 8 through a conduit 15 and a rotary union 18. A strain relief 20, such as a coil spring, may be disposed over part or the entirety of any fluid transfer conduits 14 and 15 if non-rigid so as maintain approximate positioning of the conduit while yet allowing some displacement to minimize stress at the fittings of the fluid conduits 14 and 15. As may be seen in FIG. 4, a fluid conduit connector may be located at any part of a fairing, such as approximately level with the axle (as with fluid connector 30), or toward the upper portion, as with fluid connector 20).

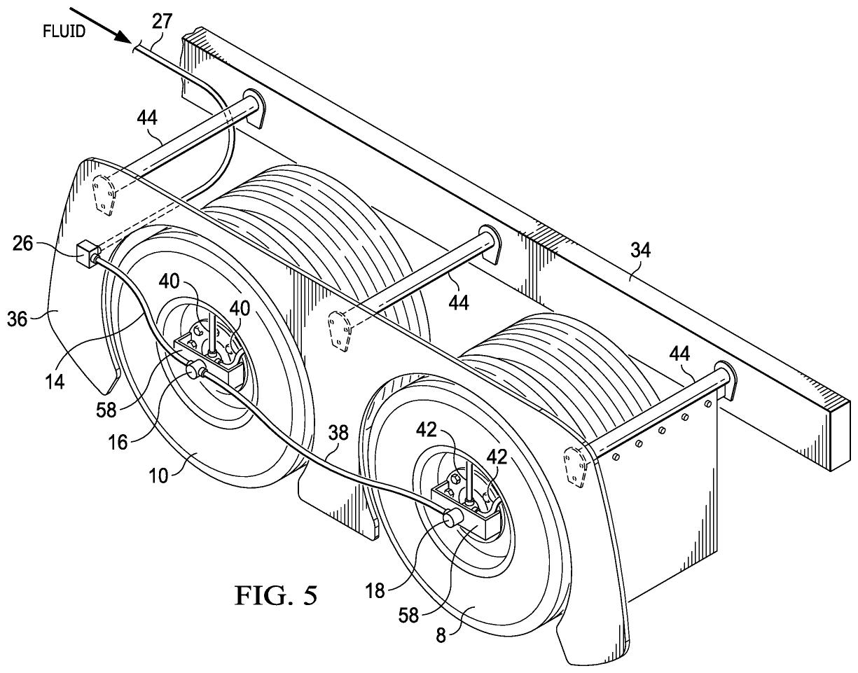

In another embodiment, as seen in FIG. 5, a truck-tractor may have a fairing 36 that combines a rear, center tandem, and forward fairing into an aerodynamically-continuous surface. The fairing may conform to the wheels, or may cover all or part of the wheel end as skirting. Such fairing 36 is shown as comprising a single body, but may comprise a plurality of close-fitting panels. Such a fairing 36 may couple to the frame 34 of a truck-tractor by means of one or more support arms 44. The fairing 36 may be bolted to the support arms 44 or otherwise affixed in any suitable manner. The support arms 44 may be bolted or welded to the frame 34, or otherwise affixed in any suitable manner. A tire inflation system may be coupled to or integrated with the fairing 36 by one or more fluid conduit connectors 26, which may be located at any suitable part of the fairing 36, such as in the forward portion of the fairing 36 (as shown). The conduit connector 26 may be provided with pressurized fluid through a conduit 27 from a fluid pressure source (not shown). This conduit connector 27 may then provide pressurized fluid through a fluid conduit 14 to a rotary union 16 at the forward set of rear tires 10. A second fluid conduit 38 may then connect the rotary union 16 at the forward rear tires 10 to a second rotary union 18 at the rearmost tire set 8. The rotary union 16 may provide pressurized fluid to one or more tires in the forward set of rear tires 10 through one or more tire hoses 40. The rotary union 18 may provide pressurized fluid to one or more tires in the rearmost set of rear tires 8 through a second set of one or more tire hoses 42. A set of tires may comprise two or more tires, or may comprise a single tire, such as a wide-base tire. Thus, the number of tire hoses 40 and 42 provided for inflation may depend on the number of tires in a tire set. The air hoses 40 and 42 may connect the rotary union 16 and 18 to a tire valve stem (not shown) of the associated tires.

The rotary unions 16 and 18 may each be secured to a wheel or hub of a tire set 8 and 10 by a bracket 58. If wheel covers (not shown) are mounted to the tire set 8 and 10, then the rotary unions 16 and 18 may be secured to a wheel or hub of a tire set 8 and 10 by the wheel cover or by a wheel cover bracket or other mounting hardware, such as described herein.

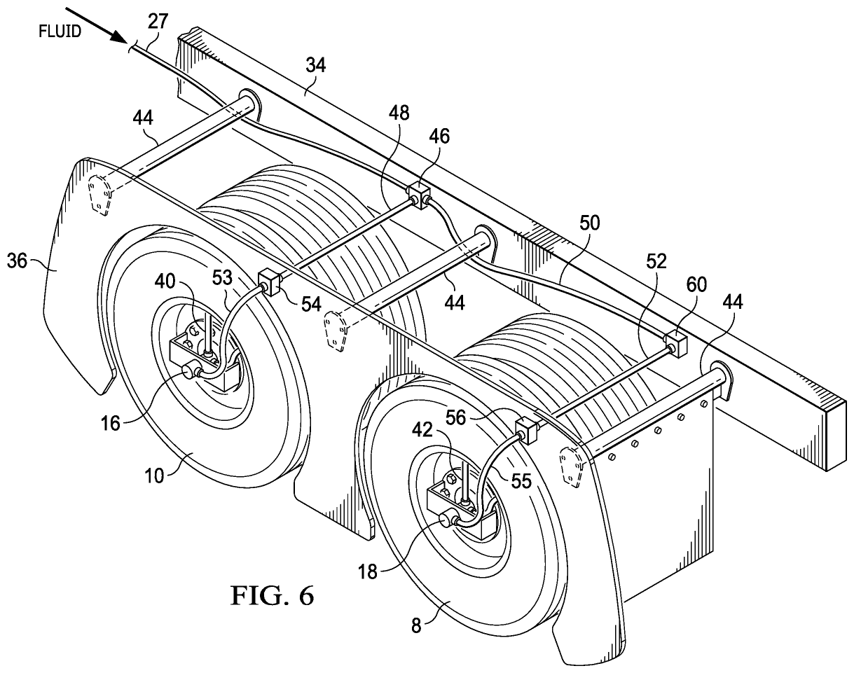

In yet another embodiment, as seen in FIG. 6, the upstream components of an inflation system may provide pressurized fluid through fluid conduit 27 to a first fluid distribution connector 46 located on the frame 34 of truck-tractor. A fluid conduit 48 may provide fluid communication between distribution connection 46 and fluid conduit connector 54 on a fairing 36 so as to supply fluid to the forward rear tire set 10. The conduit connector 54 may connect to a rotary union 16 on the forward rear tire set 10 through a fluid conduit 53. Rotary union 16 may be in fluid communication with the tires of tire set 10 through means of one or more air hoses 40.

A fluid conduit 50 may provide fluid communication between distribution connection 46 and a second distribution connection 60 on the frame 34. A fluid conduit 52 may provide fluid communication between distribution connection 60 and fluid conduit connector 56 on the fairing 36 so as to supply fluid to the rearmost rear tire set 8. The fluid conduit connector 56 may provide fluid communication through a fluid conduit 55 to the rotary union 18. A rotary union 18 may then fluidly connect to the tire through one or more air hoses 42.

In alternate embodiments, the fluid conduit 50 may extend and provide fluid communication between fluid conduit connector 54 and fluid conduit connector 56, thus avoiding the need for distribution connection 60. In yet further embodiments, the fluid conduits 48 and 52 may be provided through the support arms 44 or the support arms 44 may comprise a portion of the fluid conduits 48 and 52.

As may be seen from the foregoing embodiments, components for an external tire inflation system for may be mounted to a variety of aerodynamic fairings, covers and brackets, such as seen in the separate fairings of FIGS. 1-4, and the unibody-type fairings of FIGS. 5 and 6. A fairing set may include a fairing at the front, middle, and rear position as related to the rear tire sets 8 and 10. Alternately, the fairing set may exist as any combination of fairing positions, and include a fairing at a single position. In any and each of the possible fairing dispositions, a fluid transfer conduit may provide fluid communication between a main fluid line from the upstream supply components, such as a pressure source, and a distribution connector disposed on one or more of the fairings provided. The distribution connectors may in turn provide fluid communication to a rotary union, which in turn connects to a fluid conduit that allows communication with the associated tires. In other embodiments, various fluid connectors may be avoided by use of more robust fluid conduits extending through the fairings.

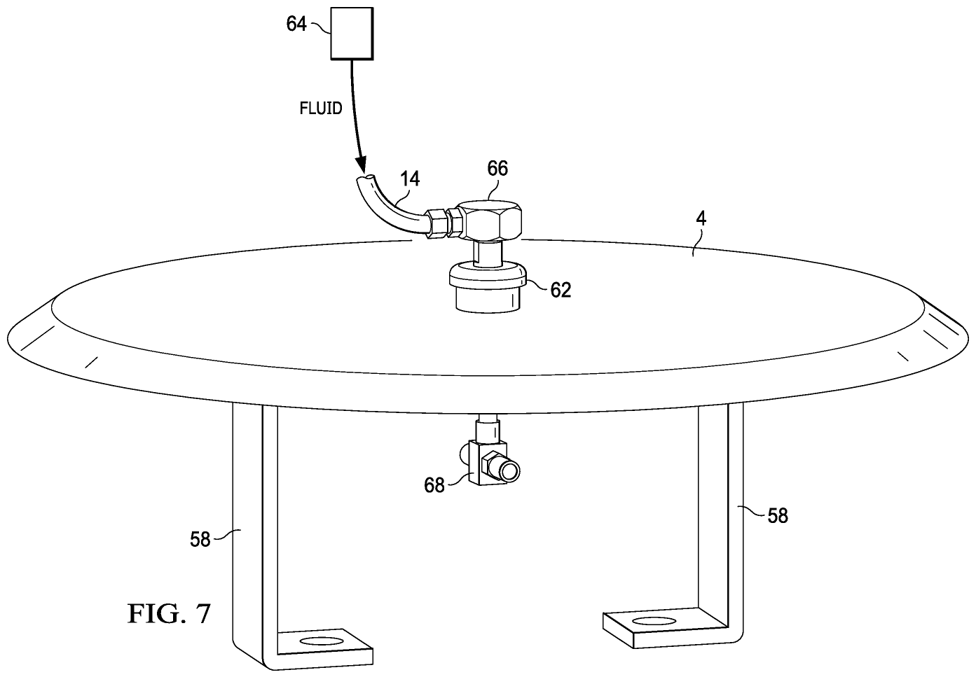

In some embodiments, a fairing set may include a wheel cover 4 disposed over a wheel hub. In other embodiments, a wheel cover may be used without use of other fairings. The wheel cover may cover substantially all of the externally-facing wheel end components, such as the hub, tire valves, lugs, and all or a substantial part of the wheel face. As may be seen in the embodiment of FIG. 7, a wheel cover 4 may be mounted to a bracket 58. The bracket 58 may be configured with bracket arms for attachment to a wheel hub. When attached to a wheel, the wheel cover may cover the wheel hub, bracket and tire hoses.

As seen in FIG. 7, a wheel cover 4 may have a rotary union 62 disposed at the center of the cover 4 so as to allow fluid communication through the wheel cover 4 to tire valves (not shown). The rotary union 62 may, for example, be of the type described in PCT/US2014/06506, entitled “Rotary Union for Tire Inflation System.” The rotary union 62 may be secured to the wheel cover 4 by any suitable fastener, such as a lock washer and nut (not pictured) at the interior face of a mounting bracket 58. In other embodiments, the rotary union may be friction fit or threaded into the wheel cover, or otherwise affixed in place by adhesive. In further embodiments, the rotary union may be formed as part of the wheel cover. In yet other embodiments, the rotary union may be mounted to a wheel-mounted bracket, and the wheel cover may be attached to the rotary union body. In yet further embodiments, the rotary union and wheel cover may both be mounted to the bracket. In other embodiments, wheel cover mounting components may be adapted to accommodate a rotary union extending through the wheel cover.

A conduit connector 66 of the rotary union 62 may be disposed at the outside face of a wheel cover 4. The fluid conduit connector 66 may maintain fluid communication with a fluid supply 64 through conduit 14. If other fairings are used, then the fluid conduit 14 may extend between the conduit connector 66 and a fluid distribution connector located on a fairing as described in foregoing embodiments.

In continuing reference to FIG. 7, the rotary union 62 may have a fluid distribution device 68. Such a device may be a tee, multi-port distribution manifold, or single outlet conduit connector extending from the interior face of a wheel cover 4, through which the fluid supply may communicate with a single tire or a set of dual tires such as tire sets 8 and 10 (shown in FIG. 1). In the embodiment of FIG. 7, the distribution tee 68 may be sealingly coupled to the aforementioned rotary union 62. Such a distribution device 68 or other connector may maintain fluid communication with the associated tires 8 and 10 through tire hoses, such as tire hoses 40 and 42 shown in FIGS. 5 and 6, extending between the distribution device 68 and a tire valve stem (not pictured). Such a fluid conduit may be suitable for exposure to the environment as the previously disclosed fluid conduit 14 or of a less robust construction due to protection afforded by the wheel cover 4. A wheel cover 4 may attach to the vehicle by means of a bracket 58 bolted to the wheel end (not shown).

A wheel cover 4 may attach to a wheel hub by a nut and washer threaded onto a threaded lug or threaded body of a rotary union 62. In another embodiment, a wheel cover 4 may have a locking hub device 70 to secure the cover 4 to the bracket 58, such as a push-and-turn assembly or quick-release latch assembly as disclosed in U.S. Pat. No. 9,327,550, the disclosure of which is incorporated entirely herein by reference. A rotary union may be used with other types of wheel covers, however. For wheel covers mounted to the wheel end by attachment to lug posts and wire brackets, a rotary union may be disposed through a wheel cover with minimal bracket alteration.

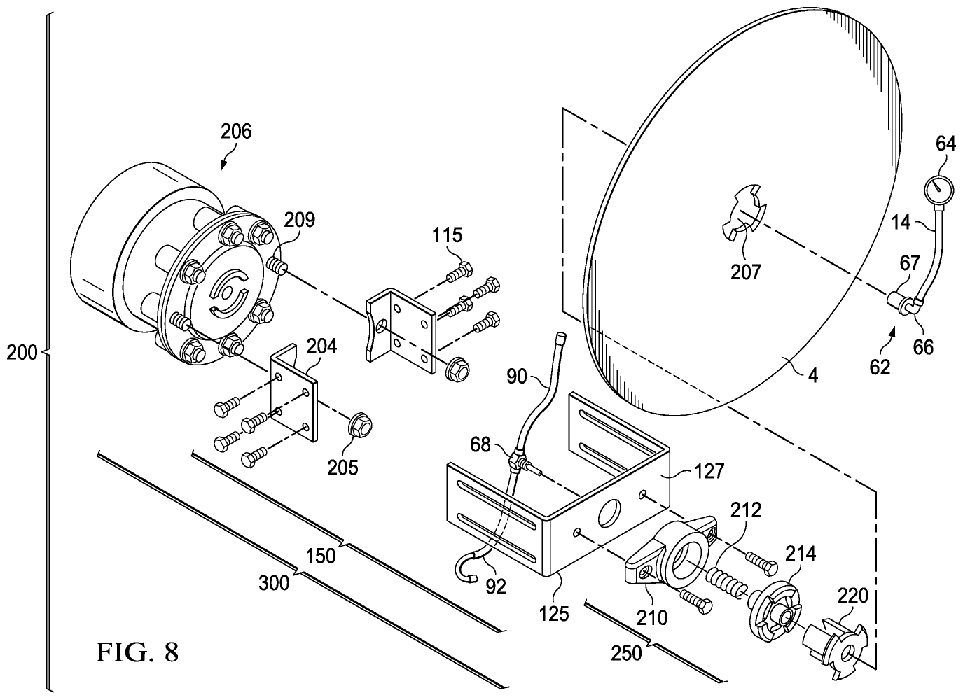

As may be seen in the push-and-turn embodiment of FIG. 8, an exploded view of one embodiment of aerodynamic wheel cover assembly 200 includes hub mounting assembly 300 and wheel cover 4. Hub mounting assembly 300 may include bracket assembly 150 and base assembly 250. Bracket assembly 150 may be configured or formed to allow access to components associated with a wheel end, such as hub 206, the rim (not shown), a tire inflation valve (not shown), lug nuts, or the like. Bracket assembly 150 may be fastenable to hub 206 such that bracket assembly 150 may be removed or installed using standard tools (e.g., sockets) or specialized tools, and may include hardware and locking mechanisms to prevent accidental or unauthorized removal of bracket assembly 150. In some embodiments, bracket assembly 150 may be connected to hub 206 utilizing studs 209 or some other pre-existing hardware associated with hub 206. In some embodiments, a non-adjustable stationary bracket (not shown) may be coupled to hub 206, such as using hub nuts 205 threaded onto studs 209. In other embodiments, adjustable bracket 125 may be coupled fixedly or pivotally to a stationary bracket base 204 using hardware 115 or some other mechanical means. Adjustable bracket 125 may be selectively coupled to stationary bracket base 204 such that the position of the outboard end of adjustable bracket 125 may be selected. That is, in the embodiment shown, the outboard position of base assembly mounting platform 127 may be adjusted. Selective adjustment of adjustable bracket 125 may be performed utilizing a series of holes, slots, or other means of positioning.

Also as depicted in FIG. 8, hub mounting assembly 200 may include base assembly 250. Base assembly 250 may be coupled to hub 206 via bracket assembly 150 to mount disk assembly 300. In some embodiments, base assembly 250 includes base 210, resilient biasing member or spring 212, piston 214 and alignment bushing 220. Base assembly 250 may be coupled with adjustable bracket 125 using hardware or other mechanical, thermal or chemical means, or may be formed integral with adjustable bracket 125.

Biasing member 212 can bias piston 214 toward alignment bushing 220 such that ribs of the bias piston fit in notches of the alignment bushing 220, and radially extending arms of the alignment bushing 220 fit in notches of the bias piston 214. By pressing on the inner shaft of the bias piston 214, the bias piston 214 may be translated in an inboard direction such that there is clearance between the inboard surfaces of radially extending arms of the alignment bushing and the outboard surfaces of the ribs configured to fit the notch between the radially extending arms of the alignment bushing 220. Consequently, wheel cover 4 may rotate for installation and removal. The tabs 207 of a wheel cover 4 are able to be positioned in the notches between the radially extending arms of the alignment bushing 220 and in contact with the ribs of the bias piston 214, and depressed and rotated behind radial arms into the notches between the ribs of the bias piston 214. In use, spring 212 exerts a force on bias piston 214 to maintain axial bias of the ribs of the bias piston 214 in the notches of alignment bushing 220, thereby trapping the tabs of the wheel cover 4 between the notches and the radial arms of the alignment bushing 220.

In some embodiments, wheel cover 4 provides a substantially continuous surface to facilitate aerodynamic flow around wheels. In other embodiments, wheel cover 4 may be configured to facilitate aerodynamic flow through the wheel cover, whereby the wheel cover may act as a fan or radial vent, for example.

As seen in FIG. 8, the hub mounting assembly 300 may be adapted to include a rotary union 62. In some embodiments, the bracket assembly 150 and base assembly 250 may be adapted to receive a rotary union 62 along the central axis of wheel rotation. In other embodiments, a rotary union may be formed as part of one or more of base 210, resilient member or spring 212, bias piston 214 and alignment bushing 220. The inner shaft of the bias piston 214 may be provided with an axial hole into which the rotary union 62 may be placed. The bias piston 214 may thus form a ring into which the rotary union housing may be disposed. In other embodiments, the bias piston 214 may form the housing of the rotary union body 67. The spring or resilient member 212 may be increased in diameter to accommodate the size of the inner shaft of the bias piston 214 when configured to receive the rotary union 62. Similarly, axial hole in the alignment bushing 220 may be sized to receive the enlarged bias piston 214. The dimensions of the base assembly 250 components may be adjusted according to the size and shape of the rotary union 62.

FIG. 18 illustrates another embodiment of a base assembly 800. In the embodiment of FIG. 18, a base 804 may be mounted to a bracket 802. An axial hole in the bias piston 806 may be sized to receive a rotary union 810. The base 804 may combines features of the base 210 and alignment bushing 220 of FIG. 8 to allow the bias piston 806 to advance toward and away from the base 804 along co-acting notches and ribs. A tab ring 808 may be mounted to the base 804, entrapping the bias piston 806 therebetween. A spring or resilient member (not shown) may be disposed between the base 804 and the bias piston 806 so as to urge the bias piston 806 toward the tab ring 808. The gap between tabs on the tab ring 808 may be configured to receive tabs of a wheel cover (not shown), which may be placed against the bias piston 806. When the wheel cover (not shown) is pressed against the bias piston 806, the bias piston 806 may move toward the base 804, thus providing a gap between the bias piston 806 and the tab ring 808. The wheel cover may be rotated so that the tabs of the wheel cover align with the tabs of the tab ring 808 and thus with corresponding notches in the bias piston 806. When pressure on the bias piston 806 is released, the spring (not shown) may urge the bias piston 806 back toward the tab ring 808, thereby entrapping the wheel cover between the bias piston 806 and the tab ring 808.

As may be seen in FIG. 8, if the base assembly 250 is configured to receive or include a rotary union 62, the rotary union may be provided in two parts. A rotary union body 67 may be mounted in one or more of the base 210, resilient member or spring 212, bias piston 214 and alignment bushing 220, depending on configuration. The rotary union may include a fluid conduit connector 66 as discussed above, to which a fluid conduit 14 may be sealingly coupled so as to convey pressurized fluid from a pressure source 64 to the rotary union 62.

A fluid distribution device 68 or tee may be coupled to the rotary union body 67 through the bracket assembly 150. Tire hoses 40 and 42 may be sealingly coupled to the fluid tee 68 to convey pressurized fluid to the vehicle tires (not shown). In some embodiments, the fluid distribution device may comprise a single distribution port for sealing coupling of a single tire hose, such as for wheel ends having a single super-wide tire.

The wheel cover 4 may be similarly configured to receive a rotary union 62. Removal of the wheel cover 4 from the wheel end may be realized by disconnecting the rotary union from the exterior fluid conduit 14. The push-and-turn hub may then by engaged to release the cover 4 from the base assembly 250. The cover may then be pulled away from the wheel end to expose the tire hoses that are connected to the tire stem valve. With the connections for the tire hoses exposed, said tire hoses may be disengaged from the rotary union 62.

Rapid engagement and disengagement of the wheel cover may be possible through the use of quick disconnect connectors at the points in which fluid conduits engage the rotary union. In other embodiments, said rotary union may be permanently joined to the base assembly 250, which in turn may incorporate the wheel cover 4, such that the rotary union is joined to the wheel cover 4.

The bracket 58 may be provided in one or more components to form the entire bracket assembly. As seen in FIGS. 7-8, the bracket 58 may comprise a plurality of components, e.g., two legs and a cross-bar fastened between said legs. The legs may have a general L-shape to permit ready mounting to a wheel end. The lower portion of the legs may contain holes for attaching the bracket to a wheel hub via threaded fastener, such as a bolt. The upper section of the legs may have a plurality of holes disposed such that the cross bar may be adjusted for height. The cross-bar may be adapted for mounting a rotary union and/or wheel cover. For example, a larger hole may be provided in the cross-bar so as to allow a rotary union to extend through the bracket 58.

In other embodiments, a mounting bracket may be provided without a height-adjustment feature. In such an embodiment, the cross member is no longer a separate component of the bracket but instead a unitary component of the legs.

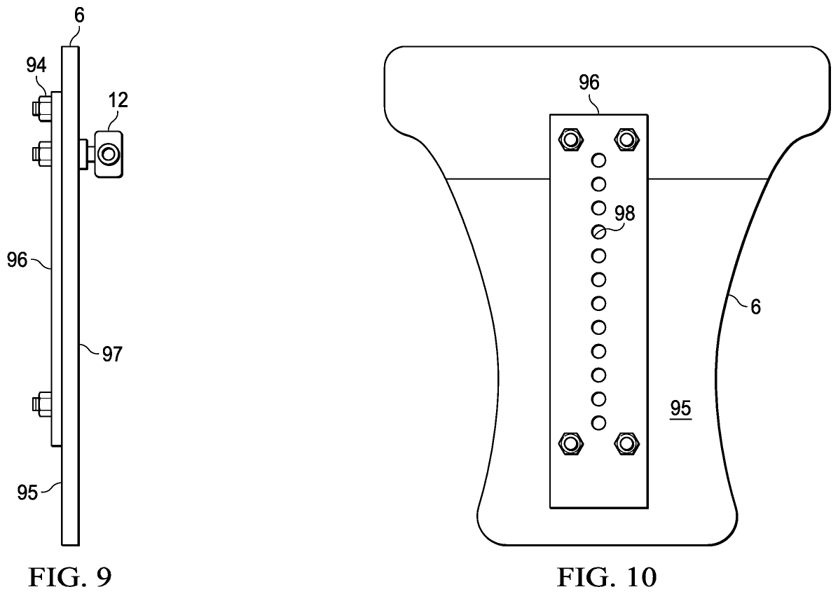

As seen in FIGS. 9 and 10, the inflation system may provide pressurized fluid for a set of tires 8 and 10 through a center tandem fairing 6. The center fairing 6 may have a fluid distribution connection 12 or other such manifold connected such that the supply fluid is delivered from the interior face 95 of the fairing 6 and the fluid is delivered to the connected tires 8 and 10 from the exterior face 97 of the fairing 6. The distribution connector 12 may be coupled to the fairing 6 by any suitable fastener, such as with a nut and lock washer 94, on the interior face of the fairing 6. Alternately, the fairing 6 may maintain an integrated threaded connection to accept a distribution connector that contains a threaded lug.

The center fairing 6 may include a plate 96 on the interior face for the aforementioned nut and washer 94 to abut for reinforcement purposes. Stresses and forces from the nut and washer 94 may be applied to such a plate 96 so to avoid applying the stresses to the body of center fairing 6, which may be formed of material unsuitable for high stress applications arising from direct contact with a nut and washer.

As seen in FIG. 10, the plate 96 may include a plurality of holes 98, such as along a vertical axis. These holes 98 may be provided so as to accept a threaded lug (not shown in FIG. 10) of the distribution connector 12 to which the nut and washer 94 attached at the topmost hole or any other hole as desired during installation of the inflation system. A plurality of holes 98 may be provided so as to allow for alternate placements of the center fairing 6 in relation to a supporting member of the truck-tractor 2. The plate 96 itself may be bolted to the body of the center fairing, such as through a rectangular four-bolt pattern, so as to distribute stresses across the body of the center fairing 6. Such a bolt pattern may also serve to attenuate or eliminate any vibrations between the plate 96 and fairing 6. Fluid conduit connectors and distribution connectors located on an exterior face of a fairing body 36, 6, 22, and 28 as disclosed above may be coupled to any such fairing 36, 6, 22, and 28 through the method disclosed for this center tandem fairing 6. Any other fairing 36, 22, and 28 as previously disclosed may employ a plate 96 and any associated feature of said plate 96.

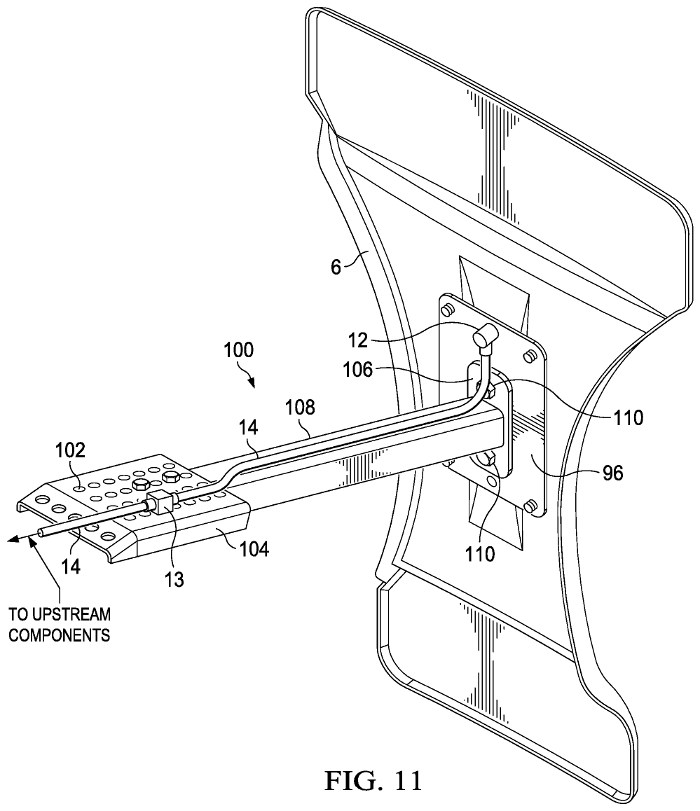

As illustrated in FIG. 11, a center fairing 6 may couple to a truck frame (not shown) through a supporting arm 100. Any fairing 6, 28, 22, and 18 of the preceding embodiments may couple to a truck-tractor by such a support arm 100. A support arm 100 may be configured so as to adjustably mount a fairing to a truck frame. The support arm 100 may comprise a base bracket 104, an end plate 106, and an interconnecting arm 108. The base bracket 104 may have a pattern of holes 102 so disposed as to allow adjustment of the interconnection arm 108 and the placement of distribution connectors 12. The base bracket 104 may couple the fender support arm 100 to a truck frame while the end plate 106 couples to a fairing 6, 28, 22, or 18 at a receiving plate 96 located on the fairing. The end plate 106 may be bolted to the receiving plate 96 with one or more bolts 110. Any suitable vehicle fairings may be used, such as those described in U.S. Pat. No. 9,027,983, the disclosure of which is wholly incorporated herein.

Such a support arm 100 may exist as a single arm per fairing or as complement of arms as may be appropriate for the style of fairing in use. For example, a system employing a separate fairing 6, 28, and 22 as in FIG. 1 at each location as related to the tire sets 8 and 10 may utilize a single support arm at each fairing body. Such may be the case for a system that employs a fairing 6, 28, or 22 at an individual location in relation to a tire set 8 and 10. A fairing 18 that forms a single body or unified face (as in FIG. 5) from the forwardmost to rearmost tire sets 8 and 10 may utilize one or more support arms 100 at the forward, midbody, and/or rear areas of the fairing 18 so as to provide proper support for the entire fairing 18.

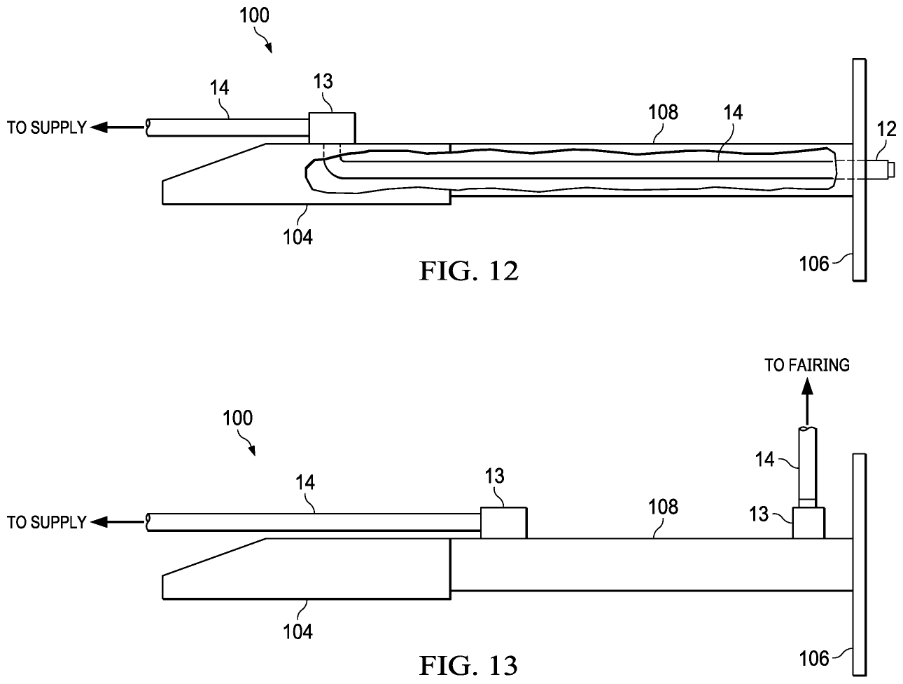

A support arm 100 may integrate components of an inflation system integrated in a variety of ways. For example, such components may comprise fluid conduits 14, fluid interconnections 13, and fluid connectors 12. A fluid interconnection 13 may be disposed at a hole 102 of the base bracket 104 for mounting the fluid conduit 14 to the base bracket 104. In other embodiments, the fluid conduit 14 may be mounted to the base bracket 104 by a clamp or bracket. The fluid conduit 14 may be routed along the exterior of the interconnecting arm 108 and be securely attached to the exterior surface of said arm 108. Such means of securing the hose 14 to the exterior of the arm 108 may include brackets, cable ties, glues, epoxies, and any other appropriate coupling device or method. Alternately, as illustrated in FIG. 12, the fluid conduit 14 connecting the fairing distribution connector 12 and the support arm distribution connector 12 may be routed through the interior of the interconnecting arm 108.

In yet another embodiment, as seen in FIG. 13, the interconnecting arm 108 of the fender support arm 100 may be sealed and pressurized thus acting as a pressure reservoir for tire inflation operations. In such a configuration, the fender support arm 100 may have fluid interconnections 13 that facilitate fluid communication between upstream components, the support arm 100, and downstream components that lead to the tire. For example, the interconnecting arm 108 may have an air hose fitting 13 disposed on the pressurized arm 108 such that the arm is pressurized by upstream components and an air hose fitting 13 configured such that the distribution connector (not shown) at the fairing (not shown) connects to the pressurized arm 108 by means of a hose 14.

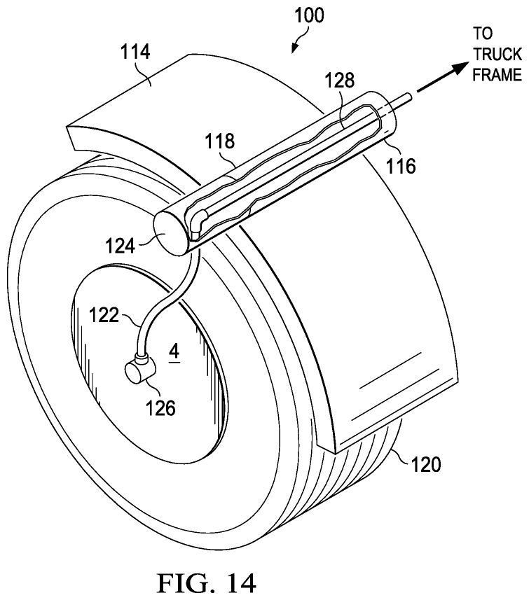

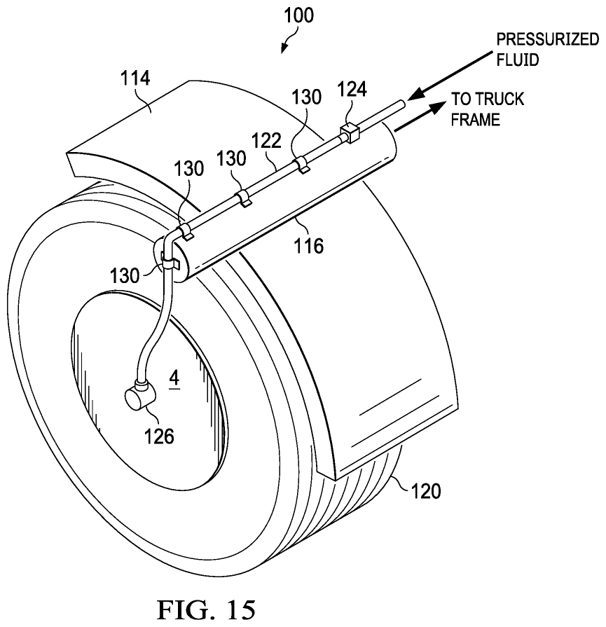

In other embodiments, as seen in FIGS. 14-15, components for an inflation system may be routed through or along the support members 116 of other ancillary wheel-related equipment 114 such as mud flaps or wheel fenders. Such support members may be provided as an arm 116 extending from the vehicle and the ancillary equipment 114 coupled to said arm 116. Such an arm 116 may take a variety of configurations, such as a hollow tube, solid bar, channel, beam or plate.

Referring to FIG. 14, pressurized fluid may be provided through the arm 116. In some embodiments, the distal end 118 of the arm 116 may have a distribution connection 124 disposed thereat such that the distribution connector 124 seals the distal end of the arm 116 so that the arm 116 may be pressurized. A fluid conduit 122 connected to the distribution connector 124 provides fluid communication between the pressurized support arm 116 and a tire 120. Such a conduit 122 may connect to a tire 120 by means of a rotary union 126 disposed through the wheel cover 4 at the wheel end.

Referring further to FIG. 14, in another embodiment a fluid conduit 128 may be routed through a hollow arm 116 so that the conduit 128 connects to a fluid distribution connector 124 at the distal end of the arm 116. Conduit 122 may then maintain fluid communication with a tire 120 by being connected to a rotary union 126 at the wheel end and the distribution connector 124 at the arm 116. Alternately, the fluid conduit 128 may be route through the arm 116 and directly connect to the rotary union 126 and thus bypass the need for a distribution connector 124 or second fluid conduit 122.

Referring to FIG. 15, arms 116 having a solid body construction or lacking sufficient diameter through which to route a fluid conduit may provide a pathway along which to route a fluid conduit 122 at the exterior faces of the arm 116. A set of brackets 130 may be disposed along the desired path so as to couple the conduit 122 to the support arm 116. Said conduit may connect to upstream components by means of a distribution connector 124 and provide fluid communication between said upstream components and a tire 120 to which the conduit 122 is coupled. Said conduit 122 may couple to the tire 120 at a rotary union 126 disposed at the wheel end. In other embodiments, the third conduit 22 may be placed inside a hose loom and mounted to the support arm 116.

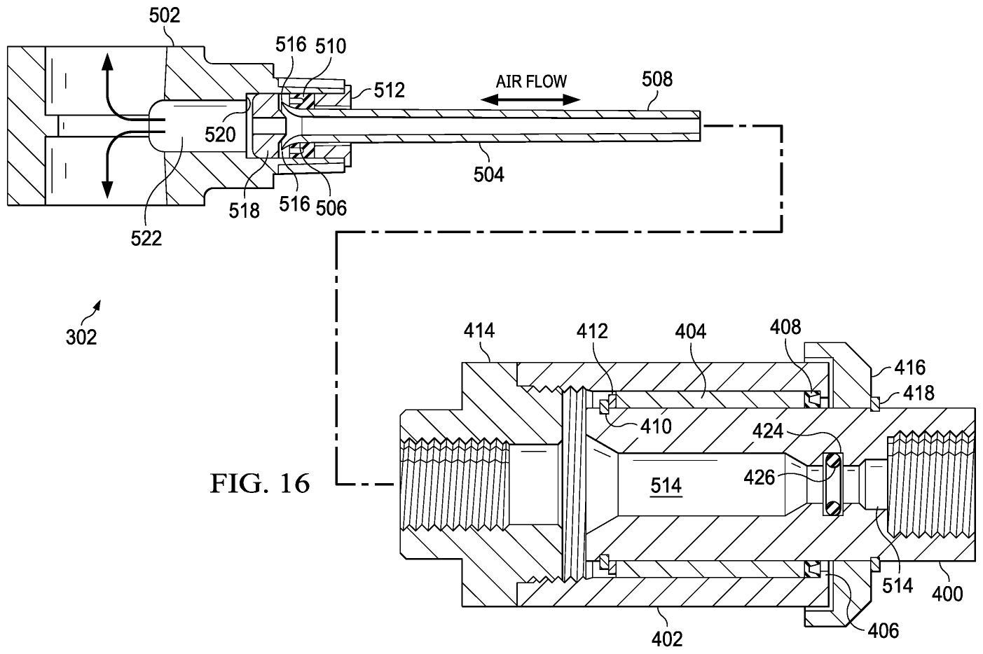

FIG. 16 illustrates in more detail an example rotary union suitable for disposition through a wheel cover. As may be seen in FIG. 16, the rotary union may comprise a shaft 400 disposed within a housing 402. A radial bushing 404 may be disposed between the shaft 400 and the housing 402. In some embodiments, the bushing 404 may comprise an oil-impregnated material, such as oilite bronze alloy, or PTFE, nylon, or any other suitable wear-resistant material with a relatively low coefficient of friction. In other embodiments, roller or ball bearings may be used in place of a bushing. The housing 402 may comprise a lip 406 which may help retain the bushing 404 within the housing 402. In some embodiments, an annular seal 408 may be disposed between the lip 406 and the bushing 404. In some embodiments, the annular seal 408 may comprise a lip seal or an o-ring.

In some embodiments, the shaft 400 may be restrained from translating within the bushing 404 (or bearing) by placement of a retaining ring 410 disposed about the shaft 400. A washer 412 may be disposed between the bushing 404 and the retaining ring 410.

In some embodiments, an end cap 414 may be coupled to the housing 402, e.g., by screw threads. In other embodiments, the housing 402 and end cap 414 may comprise a unitary item of manufacture. A splash shield 416 may be disposed about the shaft 400 against the lip 406 end of the housing 402 to shield the annular seal 408 from debris, high-volume or high-velocity liquid flow and other environmental hazards. In some embodiments, a washer (not shown) may be disposed between the splash shield 416 and the end of the housing 402. A retaining ring 418 may be used to prevent the splash shield 416 from sliding off of the shaft 400.

In some embodiments, the shaft 400 may be generally cylindrical, and may be machined or molded, for example, from steel or polycarbonate. In an interior dimension of the shaft 400, a groove 424 may be provided in which an annular seal 426, such as an o-ring, may be disposed.

FIG. 16 further shows an embodiment of a tee-shaped fluid distributor 302. In some embodiments, a tee 302 may comprise a tee body 502 and an elongated tubular member 504, preferably metal, having a first end 506 and a second end 508, all as more particularly described in U.S. Pat. No. 6,698,482 entitled “Rotary Air Connection with Bearing for Tire Inflation System,” the disclosure of which is hereby wholly incorporated by reference. In other embodiments, the tee 302 may comprise the rotary air connection as described in U.S. Pat. No. 5,769,979 entitled “Rotary Air Connection for Tire Inflation System,” the disclosure of which is hereby wholly incorporated by reference.

The first end 506 of the tubular member 504 is sealably connected to the tee body 502 by an annular seal 510. The seal 510 may be of any suitable dynamic seal allowing axial and rotational movement of the end 506, such as a lip seal or O-ring seal, and is held in place by the telescope cap 512. A tee body 502 may be threadably coupled to the end cap 414 for connection to the tire or tires at the end of the axle 12. The tee body 502 may thus be removably and non-rotatably coupled to the end cap 414. When the tee body 502 is threaded to the endcap 414, the end 508 of the tubular member 504 extends into and sealingly engages an annular seal 426, thus compensating for any misalignment or translation of the shaft 400 within the housing 402. That is, the second end 508 is coaxially extendable through and is longitudinally and rotationally movable in the passageway 514 and sealably engages an annular seal 426. The passageway 514 is in communication with a fluid supply conduit (not shown). A first resilient annular seal 426 is supported in the passageway 514 and encircles the passageway 514. The annular seals may comprise any suitable seal, such as a lip seal or O-ring, and may comprise any suitable material, such as nitrile, silicon or rubber. Tire pressurizing fluid may thus be communicated through the shaft passageway 514, the tubular member 504, and the tee body 502 (through channel 522). The tubular member may be rigid or flexible, or comprise both rigid and flexible portions. [0030] The end 506 of the tubular member 504 may include a shoulder 516 which, in commercial use, may be a convex flange. A bearing 518 may co-act with the shoulder 516, limiting the longitudinal or axial movement of the tubular member 504 and preventing the shoulder 516 from engaging the internal flange 520 on the air connection or tee body 502.

In some embodiments, the end cap 414 may be omitted, and a tee 302 may be coupled directly to the housing 300, such as by screw threads.

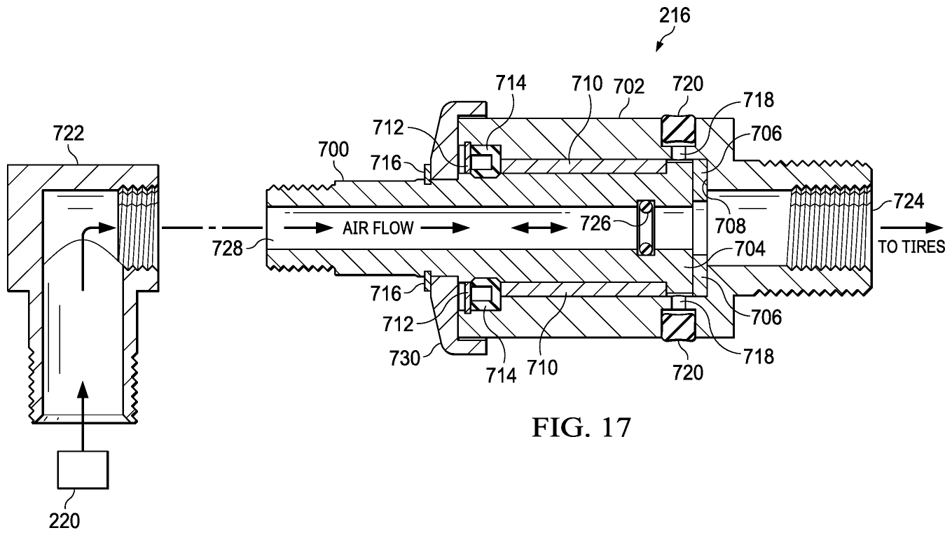

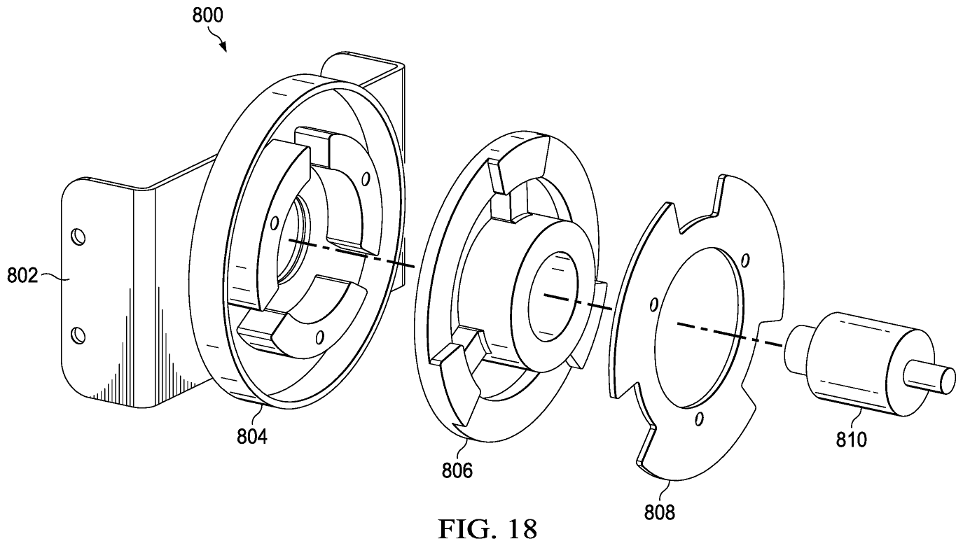

FIG. 17 illustrates another embodiment of a rotary union. A shaft 700 may be rotatably disposed within a housing 702. A thrust washer 706 may be disposed between a first end 704 of the shaft 700 and a shoulder 708 in the interior of the housing 702. The thrust washer 706 may comprise an oil-impregnated material, such as oilite bronze alloy, or PTFE, nylon, or any other suitable wear-resistant material with a relatively low coefficient of friction. In other embodiments, a thrust roller or ball bearing may be used in place of the thrust washer 706.

A radial bushing 710 may be disposed in the housing 702 about the shaft 700. The radial bushing 710 may comprise an oil-impregnated material, such as oilite bronze alloy, or PTFE, nylon, or any other suitable wear-resistant material with a relatively low coefficient of friction. In other embodiments, a roller or ball bearing may be used in place of the radial bushing. A snap ring or retainer clip 712 may be disposed about the inner diameter of the housing 702 so as to retain the shaft 700 and radial bushing 710 within the housing 702. In some embodiments, an annular seal 714, such as a lip seal, may be disposed between the inner diameter of the housing 702 and the outer diameter of the shaft 700 so as to provide a substantially sealing interface between the housing 702 and the shaft 700. A splash shield 730 may be disposed about the shaft 700 against the housing 702, and may be held in place by a retaining ring 716 disposed about the outer diameter of the shaft 700.

The housing 702 may be provided with one or more vent holes 718 to allow pressurized air to escape from the rotary union 216 in the event of seal failure (such as failure of annular seal 510 (shown in FIG. 16) or of annular seal 426 (shown in FIG. 16) or 726 (shown in FIG. 7)). An annular seal 720, such as an o-ring having a square cross section, may be elastically disposed about the housing over the vent holes 718 so as to prevent air, moisture or debris from entering the rotary union through the vent holes 718. Any other suitable seal may be used to seal the vent hole against such ingress, such as a check valve, duckbill valve, flexible diaphragm or rubber band.

In some embodiments, a hose fitting 722 may be threadably coupled to the shaft 700 to better allow for attachment of a fluid conduit carrying pressurized fluid from the pressure source 220. A tee (not shown), such as tee 302 of FIG. 5, may be threaded into the housing 702 at outlet 724. The tubular member (such as 504) of the tee may be disposed within an annular seal 726 disposed within the fluid channel 728, as described in connection with FIG. 16.

In yet further embodiments, a housing 702 may comprise a tee body 502, annual seal 510 and tubular member 504 (with reference to parts shown in FIG. 16). That is, the tee body need not be separable from the housing. Other components disclosed herein may comprise separate portions, or may comprise one or more unitary items of manufacture.

The disclosed subject matter may be thus configured, without limitation, as set forth in the following clauses:

1. A tire inflation system comprising a pressure source mounted to a vehicle having a wheel assembly comprising a tire mounted to a wheel, the pressure source being in sealed fluid communication with the tire through a rotary union; the rotary union being mounted to the wheel assembly and in sealed fluid communication with the pressure source through a fluid conduit routed outside the wheel assembly.

2. The system of clause 1, wherein the vehicle comprises a tractor or trailer, or a combination of tractor and trailer.

3. The system of clause 2, the vehicle further having a mud guard mounted adjacent the tire, the fluid conduit being mounted to the mud guard.

4. The system of clause 3, the mud guard comprising a support arm and a shield, the fluid conduit being mounted to the support arm.

5. The system of clause 3, the mud guard comprising a support arm and a shield, the support arm having a channel extending therethrough, the channel being sealed at each end so as to serve as part of the fluid conduit.

6. The system of clause 3, the mud guard comprising a support arm and a shield, the fluid conduit being at least partly disposed in the support arm.

7. The system of clause 6, further comprising a fluid connector disposed at the free end of the support arm, a first part of the fluid conduit extending from the pressure source through the support arm to the fluid connector, and a second part of the fluid conduit extending from the fluid connector to the rotary union.

8. The system of clause 7, the fluid connector being configured as an extension of the support arm.

9. The system of clause 2, further comprising an aerodynamic cover mounted to the wheel assembly, the rotary union being mounted on the wheel cover.

10. The system of clause 2, further comprising an aerodynamic cover mounted to the wheel assembly, the rotary union being disposed in the wheel cover so as to extend therethrough.

11. The system of clause 2, further comprising an aerodynamic cover mounted to the wheel assembly, the rotary union being disposed between the wheel cover and the wheel.

12. The system of clause 2, further comprising an aerodynamic cover releasably mounted to the wheel assembly, the aerodynamic cover having a release disposed in the center thereof, the release comprising the rotary union.

13. The system of clause 2, further comprising an aerodynamic fairing; and a fluid connector mounted to the fairing, a first part of the fluid conduit extending from the pressure source to the fluid connector, and a second part of the fluid conduit extending from the fluid connector to the rotary union.

14. The system of clause 13 further comprising the wheel assembly comprising a first wheel assembly; the rotary union being a first rotary union mounted to the first wheel assembly; the vehicle having a second wheel assembly adjacent the first wheel assembly, the second wheel assembly comprising a second tire mounted to a second wheel; the fairing comprising one of: a front fairing disposed adjacent the first wheel assembly toward the front of the vehicle, a center tandem fairing disposed between the first wheel assembly and the second wheel assembly, and a rear fairing disposed adjacent the second wheel assembly toward the rear of the vehicle.

15. The system of clause 14 further comprising a second rotary union mounted to the second wheel assembly; the fairing comprising the center tandem fairing; the fluid connector mounted to the fairing and having two outlet ports; and the second part of the fluid conduit comprising a first fluid hose extending from the fluid connector to the first rotary union and a second fluid hose extending from the fluid connector to the second rotary union.

16. The system of clause 14 further comprising a second rotary union mounted to the second wheel assembly; the fairing comprising the front fairing and the rear fairing; the fluid connector being a first fluid connector mounted to the front fairing; a second fluid connector mounted to the rear fairing; the first part of the fluid conduit extending to the first fluid connector and to the second fluid connector; and the second part of the fluid conduit comprising a first fluid hose extending from the first fluid connector to the first rotary union and a second fluid hose extending from the second fluid connector to the second rotary union.

17. The system of clause 14 further comprising a second rotary union mounted to the second wheel assembly; the fairing comprising the front fairing; the fluid connector being mounted to the front fairing; the second part of the fluid conduit comprising a first fluid hose extending from the fluid connector to the first rotary union and a second fluid hose providing sealed fluid communication between the first rotary union to the second rotary union.

18. The system of clause 14 further comprising a second rotary union mounted to the second wheel assembly; the fairing comprising the rear fairing; the fluid connector being mounted to the rear fairing; the second part of the fluid conduit comprising a first fluid hose extending from the fluid connector to the second rotary union and a second fluid hose providing sealed fluid communication between the second rotary union and the first rotary union.

19. The system of either of clauses 17 or 18, further comprising the fairing further comprising a center tandem fairing; the fluid connector being a first fluid connector; a second fluid connector mounted to the center tandem fairing; the second fluid hose extending from the first rotary union to the second fluid connector, and from the second fluid connector to the second rotary union.

20. The system of clause 14 further comprising a second rotary union mounted to the second wheel assembly; the fairing comprising the front fairing, the center tandem fairing and the rear fairing as a unified assembly; the fluid connector being a first fluid connector mounted to the fairing; a second fluid connector mounted to the fairing; first part of the fluid conduit extending to the first fluid connector and to the second fluid connector; and the second part of the fluid conduit comprising a first fluid hose extending from the first fluid connector to the first rotary union and a second fluid hose extending from the second fluid connector to the second rotary union.

21. The system of clause 12, the fairing being mounted to a support arm extending from a frame of the vehicle; and the first part of the fluid conduit extending along the support arm.

22. The system of clause 12, the fairing being mounted to a support arm extending from a frame of the vehicle; and the first part of the fluid conduit extending through the support arm.

23. A wheel cover system comprising a bracket assembly configured to couple to a wheel; a disk assembly comprising an inner portion; a push and turn securing mechanism coupled to the bracket assembly and compatible with the inner portion of the disk assembly, wherein the disk assembly is removably coupled to the wheel by the push and turn securing mechanism and the push and turn securing mechanism is shaped to receive the disk assembly and allow the disk assembly to rotate a fraction of a single rotation to a secured position; and a fluid rotary union disposed in the securing mechanism.

24. The wheel cover system of clause 23, wherein the disk assembly comprises an aerodynamic disk.

25. The wheel cover system of clause 23, wherein the bracket assembly is an adjustable bracket.

26. The wheel cover system of clause 23, wherein the push and turn mechanism comprises a base having an inner wall; a translatable piston for positioning in the inner wall, having an outboard side formed with one or more ribs and one or more notches, the rotary union being disposed therein; at least one spring having a first end biased by the base and a second end biasing the piston; and an alignment bushing having one or more arms and one or more notches.

27. The wheel cover system of clause 23, the piston forming part of the rotary union.

28. A wheel cover system comprising a bracket assembly assembled to couple to a wheel; a securing mechanism comprising a piston translatable along a rotational axis of a wheel; a fluid rotary union disposed in the piston; one or more retaining members coupled to the piston; a disk assembly having an inner portion, wherein the inner portion and one or more retaining members are configured such that the inner portion is translatable along the rotational axis of the wheel when the inner portion is in a first rotational position relative to the one or more retaining members and the inner portion is rotatable by a fraction of a single rotation to a secured position.

29. The wheel cover system of clause 28, wherein the piston is translatable in a base having an inner wall, wherein the securing mechanism further comprises a spring having a first end in contact with the base and a second end in contact with the piston.

30. The wheel cover system of clause 28, wherein the disk assembly comprises a plurality of tabs; and wherein the securing mechanism further comprises a base assembly comprising a base having an inner wall having a plurality of extensions separated by a plurality of channels, wherein the piston is at least partially received in the base, the outboard side formed with a plurality of ribs separated by a plurality of notches; one or more spokes, each spoke having a width less than an arc length between adjacent extensions, the plurality of spokes positioned between the extensions; and a spring having a first end in contact with the base and a second end in contact with the piston; wherein the plurality of tabs are translatable in a direction substantially parallel to a longitudinal axis of the piston to a first position, whereby the spring is deflectable relative to the longitudinal axis, wherein the plurality of tabs are rotatable about the longitudinal axis to a second position, whereby force applied by the spring maintains the plurality of tabs between the plurality of ribs.

31. The wheel cover system of clause 30, wherein the disk assembly comprises a resilient disk.

32. The wheel cover system of clause 30, wherein the piston has a shape complementary to the shape of the inner wall or the extensions.

33. A quick-release latch assembly for a vehicle wheel, comprising a bracket assembly configured to couple to a wheel; a base assembly for coupling with the bracket assembly, the base assembly comprising a base having an inner wall; a translatable piston for positioning in the inner wall, comprising a fluid rotary union disposed axially therein; an outboard side formed with one or more ribs and one or more notches; and at least one spring having a first end biased by the base and a second end biasing the piston; an alignment bushing having one or more arms and one or more notches; and a disk assembly compatible with the base assembly comprising a resilient disk having one or more tabs, wherein one or more tabs are translatable in a direction substantially parallel to a longitudinal axis of the piston to a first position, wherein the one or more tabs are rotatable about the longitudinal axis to a second position, whereby force applied by the spring maintains the second position.

34. The latch assembly of clause 34, the piston forming part of the rotary union.

35. The latch assembly of clause 34, wherein the tabs are formed with a thickness greater than a thickness of the resilient disk.

36. The latch assembly of clause 33, wherein the piston comprises an inner shaft, wherein a plurality of spokes connect the inner shaft to an outer ring of the piston and wherein depression of the inner shaft depresses the spring in the piston.

37. The latch assembly of clause 33, wherein one or more of the base, the piston and the resilient disk are formed from ABS plastic.

38. The latch assembly of clause 33, the one or more tabs being formed of a ring to which the resilient disk may be removably mounted.

39. The latch assembly of clause 33, wherein axial extensions are formed on the base or the piston.

40. The latch assembly of clause 33, wherein the piston further includes an inner shaft coupled to an outer ring by a plurality of spokes.

41. The latch assembly of clause 33, wherein the disk assembly comprises a disk formed from a resilient material.

42. The latch assembly of clause 23, wherein the disk assembly is radially vented.

43. The latch assembly of clause 23, wherein the disk assembly is formed from a clear material to allow a view of a component of the wheel.

44. The latch assembly of clause 23, wherein the inner portion of the rim may be exposed while the disk assembly is in a secured position.

45. The latch assembly of clause 23, wherein the disk assembly has one or more insets to assist in removal or installation of the disk assembly.

46. A fairing assembly adapted to couple to a vehicle, the assembly comprising an arm comprising one or more mud flap mounts to mount a mud flap; a fairing coupled to the arm, the fairing positioned on an outboard side of the mud flap, the fairing having an inboard surface and an outboard surface, the fairing outboard surface comprising an aerodynamic outer surface to direct air flow about the vehicle; an adapter coupled to the fairing and to the arm at a distal end of the arm, wherein the adapter is configured such that the fairing is mountable in one or more mounting positions; and a fluid connector mounted to the fairing, the fluid adaptor being configured to convey pressurized fluid from a pressure source to a rotary union mounted to a wheel end assembly.

47. The fairing assembly of clause 46, wherein the adapter comprises an adapter plate that defines a set of adapter mounting holes and a set of fairing mounting holes.

48. The fairing assembly of clause 47, wherein the set of adapter mounting holes align with a set of end holes at the end of the arm in a plurality of positions and the fairing mounting holes align with a set of fairing holes defined in the fairing.

49. The fairing assembly of clause 47, wherein the fairing assembly further comprises a second plate coupled to the arm; the set of adapter mounting holes align with a set of holes in the second plate in a plurality of positions; and the fairing mounting holes align with a set of fairing holes defined in the fairing.

50. The fairing assembly of clause 46, wherein the rearward angle comprises a rearward and outward angle.

51. The fairing assembly of clause 46, wherein the rearward angle comprises a rearward and inward angle.

52. A fairing assembly adapted to couple to a vehicle, the assembly comprising an arm comprising one or more mud flap mounts to mount a mud flap; a fairing coupled to the arm, the fairing positioned on an outboard side of the mud flap, the fairing having an inboard surface and an outboard surface, the fairing outboard surface comprising an aerodynamic outer surface to direct flow in a rearward angle; and a fluid connector mounted to the fairing, the fluid adaptor being configured to convey pressurized fluid from a pressure source to a rotary union mounted to a wheel end assembly.

53. The fairing assembly of clause 52, wherein the length of the arm is adjustable.

54. The fairing assembly of clause 53, wherein the mud flap and fairing mount to the main body.

55. A fairing assembly adapted to position a fairing behind a wheel of a vehicle having a set of wheels, the fairing assembly comprising a base configured to mount to a frame rail of the vehicle; an arm coupled to the base at a proximate end and extending laterally; an adapter at a distal end of the arm; and a fairing configured to be located behind a wheel, the fairing coupled to the adapter in a mounting position selected from one or more mounting positions, the fairing comprising a leading edge and a trailing edge, at least one of the fairing leading or trailing edges having a shape substantially corresponding to a wheel shape; an inboard surface and an outboard surface, the fairing outboard surface comprising an aerodynamic outer surface to direct flow in a rearward angle; and a fluid connector mounted to the fairing, the fluid adaptor being configured to convey pressurized fluid from a pressure source to a rotary union mounted to a wheel end assembly.

56. The fairing assembly of clause 55, wherein the one or more mounting positions comprise a plurality of vertical positions.

57. The fairing assembly of clause 55, wherein the one or more mounting positions comprise a plurality of horizontal positions.

58. The fairing assembly of clause 55, wherein the one or more mounting positions comprise a plurality of rotational positions.

59. The fairing assembly of clause 55, wherein the arm comprises an adjustable length arm.

60. The fairing assembly of clause 59, wherein the fairing assembly is adapted to mount between a front tandem wheel and a rear tandem wheel and the fairing further comprises a middle section; an upper section; and a lower section spaced separated from the upper section by the middle section; and wherein the upper section and the lower section are more deflectable than the middle section and wherein the upper section is positioned to clear a bottom of a trailer and the lower section is positioned to clear the ground.

61. The fairing assembly of clause 55, wherein the adapter comprises a plate defining a set of adapter mounting holes and a set of fairing mounting holes, the set of adapter mounting holes aligning with a set of end holes at the end of the arm in a plurality of positions and the fairing mounting holes aligning with a set of fairing holes.

62. The fairing assembly of clause 55, wherein the base comprises a bracket comprising a first section coupled to the arm; and a second section comprising one or more openings spaced to correspond to openings in the frame rail.

63. The fairing assembly of clause 62, wherein the first section is angled downward from the second section a first angle.

64. The fairing assembly of clause 55, wherein the adapter comprises a lateral extension comprising one or more openings that align with one or more mud flap mounts defined in the arm.

65. An aerodynamic system for a vehicle comprising a first fairing assembly comprising a first arm coupled to the vehicle; and a fairing coupled to an outboard end of the first arm, the fairing having an outer surface to direct airflow leaving a wheel in a first rearward angle; one or more additional aerodynamic components configured to act in conjunction with the fairing assembly to reduce aerodynamic drag of the vehicle; and a fluid connector mounted to the fairing, the fluid adaptor being configured to convey pressurized fluid from a pressure source to a rotary union mounted to a wheel end assembly.

66. The aerodynamic system of clause 65, wherein the first fairing assembly comprises a mud flap fairing assembly and the one more additional aerodynamic components comprise at least one of an aerodynamic quarter fender, an aerodynamic wheel cover or a middle fairing.

67. The aerodynamic system of clause 65, wherein the first fairing assembly comprises a mud flap fairing assembly mounted to a rear set of wheels of a tandem set of wheels and the one or more additional aerodynamic components comprises a middle fairing assembly, further comprising a second arm coupled to the vehicle between a forward set of wheels and the rear set of wheels of the tandem set of wheels; and a middle fairing mounted to the second arm, the middle fairing having an outboard surface to direct airflow in a second rearward angle.

68. The aerodynamic system of clause 67, further comprising aerodynamic wheel covers coupled to the rear set of wheels and the forward set of wheels.

69. The aerodynamic system of clause 67, wherein the first fairing comprises a curved leading edge and the middle fairing comprises a curved middle fairing leading edge and curved middle fairing trailing edge.

70. The aerodynamic system of clause 67, wherein the first fairing comprises a leading edge laterally positioned between an outer edge of a rear tire and a tread of the rear tire.

71. The rotary union of any of clauses 1-70 comprising a housing; a shaft rotatably disposed within the housing; a tee body removably and non-rotatably coupled to the housing; a tubular member having a first end sealingly disposed in the shaft and a second end sealingly disposed in the tee body.

72. The rotary union of clause 71, further comprising a radial bushing or bearings disposed within the housing about the shaft; and a thrust bushing or thrust bearings disposed between a first end of the shaft and an interior surface of the housing.

73. The rotary union of clause 71, further comprising a first annular seal disposed between the shaft and the first end of the tubular member; and a second annular seal disposed between the tee body and the second end of the tubular member.

74. The rotary union of clause 73, the housing further comprising a vent hole.

75. The rotary union of clause 73, the first annular seal and the second annular seal each comprising either an o-ring or a lip seal.

76. The rotary union of clause 74, further comprising a seal closing the vent hole and configured to allow pressurized fluid to escape the rotary union if one or both of the first annular seal and the second annular seal fail.

77. The rotary union of clause 72, further comprising an annular seal disposed within the housing about the shaft adjacent the radial bushing or bearing; and a shield disposed about the shaft adjacent the housing so as to shield the annular seal from environmental hazards.

78. The rotary union of clause 72, the tee body further comprising at least one hose fitting.

79. The rotary union of clause 71, wherein the tubular member is rotatable with respect to either or both of the shaft and tee body.

80. A rotary union of clauses 1-70 comprising a housing; a shaft rotatably disposed within the housing; and a tube having a first end sealingly disposed within the shaft and a second end sealingly coupled to the housing, the tube being rotatable with respect to either or both of the shaft and housing.

81. A vehicle tire inflation system comprising a fluid pressure source; and a rotary union mounted to or under an aerodynamic wheel cover, the rotary union being in sealed fluid communication with the fluid pressure source and one or more vehicle tires.

82. A vehicle tire inflation system comprising a fluid pressure source; and a rotary union mounted to a wheel end of the vehicle and in sealed fluid communication with one or more vehicle tires, the rotary union being in sealed fluid communication with the fluid pressure source through a fluid conduit disposed through or along an aerodynamic fairing mounted to the vehicle.

Although the present disclosed subject matter and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, although the disclosed apparatus, systems and methods may be described with reference to a manual or manually-activated pressure reduction valve, an electric valve or other automatic electronic or mechanical valve may be used to accomplish relatively rapid reduction of fluid pressure. Accordingly, the appended claims are intended to include within their scope such processes, machines, manufacture, compositions of matter, means, methods, systems or steps.

We claim:

1. A tire inflation system comprising:
a pressure source mounted to a vehicle having a wheel assembly comprising a tire mounted to a wheel, the pressure source being in sealed fluid communication with the tire through a rotary union;
the rotary union being mounted to the wheel assembly and in sealed fluid communication with the pressure source through a fluid conduit routed outside the wheel assembly.

2. The system of claim 1, wherein the vehicle comprises a tractor or trailer, or a combination of tractor and trailer.

3. The system of claim 2, the vehicle further having a mud guard mounted adjacent the tire, the fluid conduit being mounted to the mud guard.

4. The system of claim 3, the mud guard comprising a support arm and a shield, the fluid conduit being mounted to the support arm.

5. The system of claim 3, the mud guard comprising a support arm and a shield, the support arm having a channel extending therethrough, the channel being sealed at each end so as to serve as part of the fluid conduit.

6. The system of claim 3, the mud guard comprising a support arm and a shield, the fluid conduit being at least partly disposed in the support arm.

7. The system of claim 6, further comprising a fluid connector disposed at the free end of the support arm, a first part of the fluid conduit extending from the pressure source through the support arm to the fluid connector, and a second part of the fluid conduit extending from the fluid connector to the rotary union.

8. The system of claim 7, the fluid connector being configured as an extension of the support arm.

9. The system of claim 2, further comprising an aerodynamic cover mounted to the wheel assembly, the rotary union being mounted on the wheel cover.

10. The system of claim 2, further comprising an aerodynamic cover mounted to the wheel assembly, the rotary union being disposed in the wheel cover so as to extend therethrough.

11. The system of claim 2, further comprising an aerodynamic cover mounted to the wheel assembly, the rotary union being disposed between the wheel cover and the wheel.

12. The system of claim 2, further comprising an aerodynamic cover releasably mounted to the wheel assembly, the aerodynamic cover having a release disposed in the center thereof, the release comprising the rotary union.

13. The system of claim 2, further comprising:
an aerodynamic fairing; and
a fluid connector mounted to the fairing, a first part of the fluid conduit extending from the pressure source to the fluid connector, and a second part of the fluid conduit extending from the fluid connector to the rotary union.

14. The system of claim 13 further comprising:
the wheel assembly comprising a first wheel assembly;
the rotary union being a first rotary union mounted to the first wheel assembly;
the vehicle having a second wheel assembly adjacent the first wheel assembly, the second wheel assembly comprising a second tire mounted to a second wheel;
the fairing comprising one of: a front fairing disposed adjacent the first wheel assembly toward the front of the vehicle, a center tandem fairing disposed between the first wheel assembly and the second wheel assembly, and a rear fairing disposed adjacent the second wheel assembly toward the rear of the vehicle.

15. The system of claim 14 further comprising:
a second rotary union mounted to the second wheel assembly;
the fairing comprising the center tandem fairing;
the fluid connector mounted to the fairing and having two outlet ports; and
the second part of the fluid conduit comprising a first fluid hose extending from the fluid connector to the first rotary union and a second fluid hose extending from the fluid connector to the second rotary union.

16. The system of claim 14 further comprising:
a second rotary union mounted to the second wheel assembly;
the fairing comprising the front fairing and the rear fairing;
the fluid connector being a first fluid connector mounted to the front fairing;
a second fluid connector mounted to the rear fairing;
the first part of the fluid conduit extending to the first fluid connector and to the second fluid connector; and
the second part of the fluid conduit comprising a first fluid hose extending from the first fluid connector to the first rotary union and a second fluid hose extending from the second fluid connector to the second rotary union.

17. The system of claim 14 further comprising:
a second rotary union mounted to the second wheel assembly;
the fairing comprising the front fairing;
the fluid connector being mounted to the front fairing;
the second part of the fluid conduit comprising a first fluid hose extending from the fluid connector to the first rotary union and a second fluid hose providing sealed fluid communication between the first rotary union to the second rotary union.

18. The system of claim 14 further comprising:
a second rotary union mounted to the second wheel assembly;
the fairing comprising the rear fairing;
the fluid connector being mounted to the rear fairing;
the second part of the fluid conduit comprising a first fluid hose extending from the fluid connector to the second rotary union and a second fluid hose providing sealed fluid communication between the second rotary union and the first rotary union.

19. The system of either of claim 17 or 18, further comprising:
the fairing further comprising a center tandem fairing;
the fluid connector being a first fluid connector;
a second fluid connector mounted to the center tandem fairing;
the second fluid hose extending from the first rotary union to the second fluid connector, and from the second fluid connector to the second rotary union.

20. The system of claim 14 further comprising:
a second rotary union mounted to the second wheel assembly;
the fairing comprising the front fairing, the center tandem fairing and the rear fairing as a unified assembly;
the fluid connector being a first fluid connector mounted to the fairing;
a second fluid connector mounted to the fairing;
first part of the fluid conduit extending to the first fluid connector and to the second fluid connector; and
the second part of the fluid conduit comprising a first fluid hose extending from
the first fluid connector to the first rotary union and a second fluid hose extending from the second fluid connector to the second rotary union.

21. The system of claim 12, the fairing being mounted to a support arm extending from a frame of the vehicle; and the first part of the fluid conduit extending along the support arm.

22. The system of claim 12, the fairing being mounted to a support arm extending from a frame of the vehicle; and the first part of the fluid conduit extending through the support arm.

23. A wheel cover system comprising:
a bracket assembly configured to couple to a wheel;
a disk assembly comprising an inner portion;
a push and turn securing mechanism coupled to the bracket assembly and compatible with the inner portion of the disk assembly, wherein the disk assembly is removably coupled to the wheel by the push and turn securing mechanism and the push and turn securing mechanism is shaped to receive the disk assembly and allow the disk assembly to rotate a fraction of a single rotation to a secured position; and
a fluid rotary union disposed in the securing mechanism.

24. The wheel cover system of claim 23, wherein the disk assembly comprises an aerodynamic disk.

25. The wheel cover system of claim 23, wherein the bracket assembly is an adjustable bracket.

26. The wheel cover system of claim 23, wherein the push and turn mechanism comprises:
a base having an inner wall;
a translatable piston for positioning in the inner wall, having an outboard side formed with one or more ribs and one or more notches, the rotary union being disposed therein;
at least one spring having a first end biased by the base and a second end biasing the piston; and
an alignment bushing having one or more arms and one or more notches.

27. The wheel cover system of claim 23, the piston forming part of the rotary union.

28. A wheel cover system comprising:
a bracket assembly assembled to couple to a wheel;
a securing mechanism comprising:
a piston translatable along a rotational axis of a wheel;
a fluid rotary union disposed in the piston;
one or more retaining members coupled to the piston;
a disk assembly having an inner portion, wherein the inner portion and one or more retaining members are configured such that the inner portion is translatable along the rotational axis of the wheel when the inner portion is in a first rotational position relative to the one or more retaining members and the inner portion is rotatable by a fraction of a single rotation to a secured position.

29. The wheel cover system of claim 28, wherein the piston is translatable in a base having an inner wall, wherein the securing mechanism further comprises a spring having a first end in contact with the base and a second end in contact with the piston.

30. The wheel cover system of claim 28, wherein the disk assembly comprises:
a plurality of tabs; and
wherein the securing mechanism further comprises a base assembly comprising:
a base having an inner wall having a plurality of extensions separated by a plurality of channels, wherein the piston is at least partially received in the base, the outboard side formed with a plurality of ribs separated by a plurality of notches;
one or more spokes, each spoke having a width less than an arc length between adjacent extensions, the plurality of spokes positioned between the extensions; and
a spring having a first end in contact with the base and a second end in contact with the piston;
wherein the plurality of tabs are translatable in a direction substantially parallel to a longitudinal axis of the piston to a first position, whereby the spring is deflectable relative to the longitudinal axis,
wherein the plurality of tabs are rotatable about the longitudinal axis to a second position, whereby force applied by the spring maintains the plurality of tabs between the plurality of ribs.

31. The wheel cover system of claim 30, wherein the disk assembly comprises a resilient disk.

32. The wheel cover system of claim 30, wherein the piston has a shape complementary to the shape of the inner wall or the extensions.

33. A quick-release latch assembly for a vehicle wheel, comprising:
a bracket assembly configured to couple to a wheel;
a base assembly for coupling with the bracket assembly, the base assembly comprising:
a base having an inner wall;
a translatable piston for positioning in the inner wall, comprising:
a fluid rotary union disposed axially therein;
an outboard side formed with one or more ribs and one or more notches; and
at least one spring having a first end biased by the base and a second end biasing the piston;
an alignment bushing having one or more arms and one or more notches; and
a disk assembly compatible with the base assembly comprising:
a resilient disk having one or more tabs,
wherein one or more tabs are translatable in a direction substantially parallel to a longitudinal axis of the piston to a first position,
wherein the one or more tabs are rotatable about the longitudinal axis to a second position, whereby force applied by the spring maintains the second position.

34. The latch assembly of claim 34, the piston forming part of the rotary union.

35. The latch assembly of claim 34, wherein the tabs are formed with a thickness greater than a thickness of the resilient disk.

36. The latch assembly of claim 33, wherein the piston comprises:
an inner shaft, wherein a plurality of spokes connect the inner shaft to an outer ring of the piston and wherein depression of the inner shaft depresses the spring in the piston.

37. The latch assembly of claim 33, wherein one or more of the base, the piston and the resilient disk are formed from ABS plastic.

38. The latch assembly of claim 33, the one or more tabs being formed of a ring to which the resilient disk may be removably mounted.

39. The latch assembly of claim 33, wherein axial extensions are formed on the base or the piston.

40. The latch assembly of claim 33, wherein the piston further includes an inner shaft coupled to an outer ring by a plurality of spokes.

41. The latch assembly of claim 33, wherein the disk assembly comprises a disk formed from a resilient material.

42. The latch assembly of claim 23, wherein the disk assembly is radially vented.

43. The latch assembly of claim 23, wherein the disk assembly is formed from a clear material to allow a view of a component of the wheel.

44. The latch assembly of claim 23, wherein the inner portion of the rim may be exposed while the disk assembly is in a secured position.

45. The latch assembly of claim 23, wherein the disk assembly has one or more insets to assist in removal or installation of the disk assembly.

46. A fairing assembly adapted to couple to a vehicle, the assembly comprising:
an arm comprising one or more mud flap mounts to mount a mud flap;
a fairing coupled to the arm, the fairing positioned on an outboard side of the mud flap, the fairing having an inboard surface and an outboard surface, the fairing outboard surface comprising an aerodynamic outer surface to direct air flow about the vehicle;
an adapter coupled to the fairing and to the arm at a distal end of the arm, wherein the adapter is configured such that the fairing is mountable in one or more mounting positions; and
a fluid connector mounted to the fairing, the fluid adaptor being configured to convey pressurized fluid from a pressure source to a rotary union mounted to a wheel end assembly.

47. The fairing assembly of claim 46, wherein the adapter comprises an adapter plate that defines a set of adapter mounting holes and a set of fairing mounting holes.

48. The fairing assembly of claim 47, wherein the set of adapter mounting holes align with a set of end holes at the end of the arm in a plurality of positions and the fairing mounting holes align with a set of fairing holes defined in the fairing.

49. The fairing assembly of claim 47, wherein:
the fairing assembly further comprises a second plate coupled to the arm;
the set of adapter mounting holes align with a set of holes in the second plate in a plurality of positions; and
the fairing mounting holes align with a set of fairing holes defined in the fairing.

50. The fairing assembly of claim 46, wherein the rearward angle comprises a rearward and outward angle.

51. The fairing assembly of claim 46, wherein the rearward angle comprises a rearward and inward angle.

52. A fairing assembly adapted to couple to a vehicle, the assembly comprising:
an arm comprising one or more mud flap mounts to mount a mud flap;
a fairing coupled to the arm, the fairing positioned on an outboard side of the mud flap, the fairing having an inboard surface and an outboard surface, the fairing outboard surface comprising an aerodynamic outer surface to direct flow in a rearward angle; and
a fluid connector mounted to the fairing, the fluid adaptor being configured to convey pressurized fluid from a pressure source to a rotary union mounted to a wheel end assembly.

53. The fairing assembly of claim 52, wherein the length of the arm is adjustable.

54. The fairing assembly of claim 53, wherein the mud flap and fairing mount to the main body.

55. A fairing assembly adapted to position a fairing behind a wheel of a vehicle having a set of wheels, the fairing assembly comprising:
a base configured to mount to a frame rail of the vehicle;
an arm coupled to the base at a proximate end and extending laterally;
an adapter at a distal end of the arm; and
a fairing configured to be located behind a wheel, the fairing coupled to the adapter in a mounting position selected from one or more mounting positions, the fairing comprising:
a leading edge and a trailing edge, at least one of the fairing leading or trailing edges having a shape substantially corresponding to a wheel shape;
an inboard surface and an outboard surface, the fairing outboard surface comprising an aerodynamic outer surface to direct flow in a rearward angle; and
a fluid connector mounted to the fairing, the fluid adaptor being configured to convey pressurized fluid from a pressure source to a rotary union mounted to a wheel end assembly.

56. The fairing assembly of claim 55, wherein the one or more mounting positions comprise a plurality of vertical positions.

57. The fairing assembly of claim 55, wherein the one or more mounting positions comprise a plurality of horizontal positions.

58. The fairing assembly of claim 55, wherein the one or more mounting positions comprise a plurality of rotational positions.

59. The fairing assembly of claim 55, wherein the arm comprises an adjustable length arm.

60. The fairing assembly of claim 59, wherein the fairing assembly is adapted to mount between a front tandem wheel and a rear tandem wheel and the fairing further comprises:
a middle section;
an upper section; and
a lower section spaced separated from the upper section by the middle section; and
wherein the upper section and the lower section are more deflectable than the middle section and wherein the upper section is positioned to clear a bottom of a trailer and the lower section is positioned to clear the ground.

61. The fairing assembly of claim 55, wherein the adapter comprises a plate defining a set of adapter mounting holes and a set of fairing mounting holes, the set of adapter mounting holes aligning with a set of end holes at the end of the arm in a plurality of positions and the fairing mounting holes aligning with a set of fairing holes.

62. The fairing assembly of claim 55, wherein the base comprises a bracket comprising:
a first section coupled to the arm; and
a second section comprising one or more openings spaced to correspond to openings in the frame rail.

63. The fairing assembly of claim 62, wherein the first section is angled downward from the second section a first angle.

64. The fairing assembly of claim 55, wherein the adapter comprises a lateral extension comprising one or more openings that align with one or more mud flap mounts defined in the arm.

65. An aerodynamic system for a vehicle comprising:
a first fairing assembly comprising:
a first arm coupled to the vehicle; and
a fairing coupled to an outboard end of the first arm, the fairing having an outer surface to direct airflow leaving a wheel in a first rearward angle;
one or more additional aerodynamic components configured to act in conjunction with the fairing assembly to reduce aerodynamic drag of the vehicle; and
a fluid connector mounted to the fairing, the fluid adaptor being configured to convey pressurized fluid from a pressure source to a rotary union mounted to a wheel end assembly.

66. The aerodynamic system of claim 65, wherein the first fairing assembly comprises a mud flap fairing assembly and the one more additional aerodynamic components comprise at least one of an aerodynamic quarter fender, an aerodynamic wheel cover or a middle fairing.

67. The aerodynamic system of claim 65, wherein the first fairing assembly comprises a mud flap fairing assembly mounted to a rear set of wheels of a tandem set of wheels and the one or more additional aerodynamic components comprises a middle fairing assembly, further comprising:
a second arm coupled to the vehicle between a forward set of wheels and the rear set of wheels of the tandem set of wheels; and
a middle fairing mounted to the second arm, the middle fairing having an outboard surface to direct airflow in a second rearward angle.

68. The aerodynamic system of claim 67, further comprising aerodynamic wheel covers coupled to the rear set of wheels and the forward set of wheels.

69. The aerodynamic system of claim 67, wherein the first fairing comprises a curved leading edge and the middle fairing comprises a curved middle fairing leading edge and curved middle fairing trailing edge.

70. The aerodynamic system of claim 67, wherein the first fairing comprises a leading edge laterally positioned between an outer edge of a rear tire and a tread of the rear tire.

71. The rotary union of any of claims 1-70 comprising:
a housing;
a shaft rotatably disposed within the housing;
a tee body removably and non-rotatably coupled to the housing;
a tubular member having a first end sealingly disposed in the shaft and a second end sealingly disposed in the tee body.

72. The rotary union of claim 71, further comprising:
a radial bushing or bearings disposed within the housing about the shaft; and a thrust bushing or thrust bearings disposed between a first end of the shaft and an interior surface of the housing.

73. The rotary union of claim 71, further comprising a first annular seal disposed between the shaft and the first end of the tubular member; and a second annular seal disposed between the tee body and the second end of the tubular member.

74. The rotary union of claim 73, the housing further comprising a vent hole.

75. The rotary union of claim 73, the first annular seal and the second annular seal each comprising either an o-ring or a lip seal.

76. The rotary union of claim 74, further comprising a seal closing the vent hole and configured to allow pressurized fluid to escape the rotary union if one or both of the first annular seal and the second annular seal fail.

77. The rotary union of claim 72, further comprising:
an annular seal disposed within the housing about the shaft adjacent the radial bushing or bearing; and
a shield disposed about the shaft adjacent the housing so as to shield the annular seal from environmental hazards.

78. The rotary union of claim 72, the tee body further comprising at least one hose fitting.

79. The rotary union of claim 71, wherein the tubular member is rotatable with respect to either or both of the shaft and tee body.

80. A rotary union of claims 1-70 comprising:
a housing;
a shaft rotatably disposed within the housing; and
a tube having a first end sealingly disposed within the shaft and a second end sealingly coupled to the housing, the tube being rotatable with respect to either or both of the shaft and housing.

81. A vehicle tire inflation system comprising:
a fluid pressure source; and
a rotary union mounted to or under an aerodynamic wheel cover, the rotary union being in sealed fluid communication with the fluid pressure source and one or more vehicle tires.

82. A vehicle tire inflation system comprising:
a fluid pressure source; and
a rotary union mounted to a wheel end of the vehicle and in sealed fluid communication with one or more vehicle tires, the rotary union being in sealed fluid communication with the fluid pressure source through a fluid conduit disposed through or along an aerodynamic fairing mounted to the vehicle.
